(19) United States
(12) Patent Application Publication
(10) Pub. No.: US 2013/0263669 A1
(43) Pub. Date: Oct. 10, 2013

(54) PROBE AND MANUFACTURING METHOD THEREOF, AND OBJECT INFORMATION ACQUISITION APPARATUS USING THE SAME

(71) Applicant: CANON KABUSHIKI KAISHA, (US)

(72) Inventor: Koichiro Nakanishi, Tokyo (JP)

(73) Assignee: CANON KABUSHIKI KAISHA, Tokyo (JP)

(21) Appl. No.: 13/795,563

(22) Filed: Mar. 12, 2013

(30) Foreign Application Priority Data
Mar. 31, 2012 (JP) 2012-083418
Feb. 28, 2013 (JP) 2013-040131

(51) Int. Cl. G01H 9/00

(52) U.S. Cl. CPC G01H 9/00
USPC 73/655

(57) ABSTRACT

A probe is provided where a problem of reduction in a reflective performance of an optical reflection layer due to the surface roughness of a support layer of an optical reflection member provided on an element for reflecting irradiation light onto an object or scattered light thereof is solved. The probe includes an element including cells. The probe further includes: an optical reflection layer 108 that is provided closer to the object than the element is; a support layer 104 supporting the optical reflection layer 108; and a smooth layer 106 that is provided between the support layer and the optical reflection layer, and has a smoother surface than the surface of the support layer 104.

### BACKGROUND OF THE INVENTION

1. Field of the Invention

The present invention relates to a probe that is used as a photoacoustic probe and includes a capacitive electromechanical transducer having an optical reflection member, manufacturing method thereof, and an object information acquisition apparatus using the same.

2. Description of the Related Art

In recent years, ultrasonic diagnosis, particularly, photoacoustic tomography (PAT) using photoacoustics, has attracted attention as a technique of detecting diseases at an early stage. The technique is noninvasive to a living body and visualizes information in the living body using near-infrared light with a high transmittance. When a living body is irradiated with near-infrared light, the living body absorbs light energy and instantaneously thermally expands to thereby emit acoustic waves. The technique detects the acoustic waves and images the inside of the living body. In this specification, the acoustic waves are any of sound waves, ultrasonic waves, and photoacoustic waves. For instance, the photoacoustic waves are caused by irradiating the inside of an object with light (electromagnetic waves), such as visible or infrared light. Hereinafter, a term of “ultrasound” may be used as typical acoustic waves.

FIG. 7 is a schematic diagram of photoacoustic tomography. A diagnostic target (object) 404, such as a living body, is irradiated with a laser beam 402. Ultrasound 406 caused in the object 404 is detected by a probe 408. Ultrasound significantly attenuates in air, and is strongly reflected by an interface of substances having different acoustic impedances. Thus, an acoustic medium 400 having an acoustic impedance equivalent to that of the object and the probe is typically filled between the object 404 and the probe 408. Diagnosis is performed on a desired region in the object 404 by scanning the laser beam 402 and the probe 408 in synchronous scan with each other. When the laser beam 402 comes off the object 404, the probe 408 is directly irradiated with the beam to cause large acoustic noise. The noise may affect diagnosis. In a certain configuration, the laser beam 402 is incident on the same side as that of the probe 408. Even in this case, when scattered light enters the probe 408 and is absorbed, noise may occur. Thus, an optical reflection member reflecting the laser beam 402 can be provided on the surface of the probe 408.

Required characteristics of the optical reflection member includes: 1) a high reflectance in a wavelength region of light to be used; 2) a high transparency to a signal (ultrasound) caused from an object; and 3) acoustic impedance consistency with an ambient acoustic medium. A metal film has a high reflectance to light but has a high acoustic impedance. In consideration of acoustic impedance consistency, the metal film is required to have a thickness of about 1/30 or less of the wavelength of sound in the metal. “IEEE Transactions on Medical Imaging, Vol. 24, NO. 4, 2005 pp. 436-440 describes an optical reflection member in which a resin foil is coated with aluminum having a thickness of 8 μm. This thickness is about 1/100 of the wavelength of 10 MHz ultrasound in aluminum (642 μm), and thus sufficiently thin. Accordingly, the thickness does not seem to cause a problem in terms of acoustic impedance. However, the document does not include detailed description on the resin part, which is a support layer for the aluminum. The resin part requires the characteristics 2) and 3). In ” IEEE Transactions on Medical Imaging, Vol. 24, NO. 4, 2005 pp. 436-440, a sensor including a piezoelectric element, such as PZT, is used as an ultrasonic sensor. In recent years, a capacitive electromechanical transducer (a capacitive micromachined ultrasonic transducer (CMUT)) has also been widely used.

The CMUT has an acoustic impedance close to that of a living body. This impedance basically negates the need of an impedance matching layer, and the CMUT has a wide band. Accordingly, the CMUT is particularly suitable for an ultrasonic sensor for diagnosing a living body. Ultrasound significantly attenuates in air, which has extremely small acoustic impedance; ultrasound is substantially 100% reflected by the interface between air and another substance. Thus, an medium (acoustic medium) that is typically safe for a human body and has an acoustic impedance close to that of a living body (an acoustic impedance of about 1.5×10⁶ [kg·m⁻² ·s⁻¹]) is inserted between the living body and the ultrasonic sensor. Water (with an acoustic impedance of about 1.5×10⁶ [kg·m⁻² ·s⁻¹]) and polyethylene glycol (with an acoustic impedance about 1.8×10⁶ [kg·m⁻² ·s⁻¹]) can be used. A material having a low acoustic impedance (e.g., about 2×10⁶ [kg·m⁻² ·s⁻¹] or less) close to that of the acoustic medium of a support layer (the resin foil in IEEE Transactions on Medical Imaging, Vol. 24, NO. 4, 2005 pp. 436-440) of an optical reflection member can be used. For instance, polycarbonate resin has an acoustic impedance of about 2.6×10⁶ [kg·m⁻² ·s⁻¹], and sometimes causes reflection of ultrasound due to acoustic impedance inconformity, and reduction in sensitivity and a band degradation. Accordingly, polycarbonate resin is not suitable. Japanese Patent Application Laid-Open No. 2010-075681 discloses the optical reflection member in which polymethylpentene resin (acoustic impedance of about 1.8×10⁶ [kg·m⁻² ·s⁻¹]) is coated with the metal film, as an optical reflection member satisfying suitable conditions.

### SUMMARY OF THE INVENTION

According to the above reasons, the optical reflection member in the photoacoustic probe can be a combination of a support layer made of a low acoustic impedance (2×10⁶ [kg·m⁻² ·s⁻¹] or less) and an optical reflection layer, such as a metal thin film. However, in the case of actually using this combination as the optical reflection member, the inventor of the present invention has found the following points. First, the surface roughness of resin is to be noted. In general, it is known that, if the surface roughness is larger than 1/20 of the wavelength of light, absorption is increased owing to multiple scattering. The surface roughness is equivalent to 40 nm on and around a wavelength of 800 nm used for photoacoustics. For instance, the surface smoothness of methylpentene resin is Ra (average value of absolute values of deviations from the arithmetic mean roughness),which ranges from 30 to 100 nm. Occurrence of acoustic noise due to light absorption is concerned. In addition to if the surface is rough, a pinhole is easily formed when a metal thin film is formed. Thus, increase of acoustic noise due to light passing through the pinhole is also concerned. Secondly, the adhesive property between a support layer, such as resin, and an optical reflection layer is to be noted. If a metal thin film to be the optical reflection layer is formed on the surface of such a support layer, the adhesive force is not sufficiently large. Accordingly, if the optical reflection layer is rubbed during use, the layer may be exfoliated.

To solve the problem, the present invention has an object to provide a probe that includes an optical reflection member having a sufficient adhesive property between an optical reflection layer and a support layer, and manufacturing method thereof.

A probe of the present invention is a probe receiving an acoustic wave from an object, including: an element having at least one cell in which a vibration film containing one electrode out of two electrodes that are provided so as to interpose a space therebetween is vibratably owing to the acoustic wave; an optical reflection layer that is provided closer to the object than the element is; a support layer that is provided closer to the element than the optical reflection layer is, and supports the optical reflection layer; and a smooth layer that is provided between the support layer and the optical reflection layer and has a smoother surface than the surface of the support layer.

Further features of the present invention will become apparent from the following description of exemplary embodiments with reference to the attached drawings.

### BRIEF DESCRIPTION OF THE DRAWINGS

FIG. 1 is a sectional view of an example of a photoacoustic probe of the present invention.

FIGS. 2A, 2B and 2C are sectional views illustrating an example of a flow of steps of manufacturing a photoacoustic probe of the present invention.

FIGS. 3A, 3B, 3C, 3D and 3E are sectional views illustrating another example of a flow of steps of manufacturing a photoacoustic probe of the present invention.

FIG. 4A is a top plan view of the probe. FIG. 4B is a sectional view of a probe using a capacitive electromechanical transducer (sacrificial layer type) taken along line 4B-4B.

FIG. 5 is a sectional view of a probe using a capacitive electromechanical transducer (bonding type).

FIG. 6 is a diagram schematically illustrating the photoacoustic probe of the present invention.

FIG. 7 is a diagram schematically illustrating photoacoustic tomography.

FIG. 8 is a diagram illustrating an object information acquisition apparatus using the probe of the present invention.

### DESCRIPTION OF THE EMBODIMENTS

Preferred embodiments of the present invention will now be described in detail in accordance with the accompanying drawings.

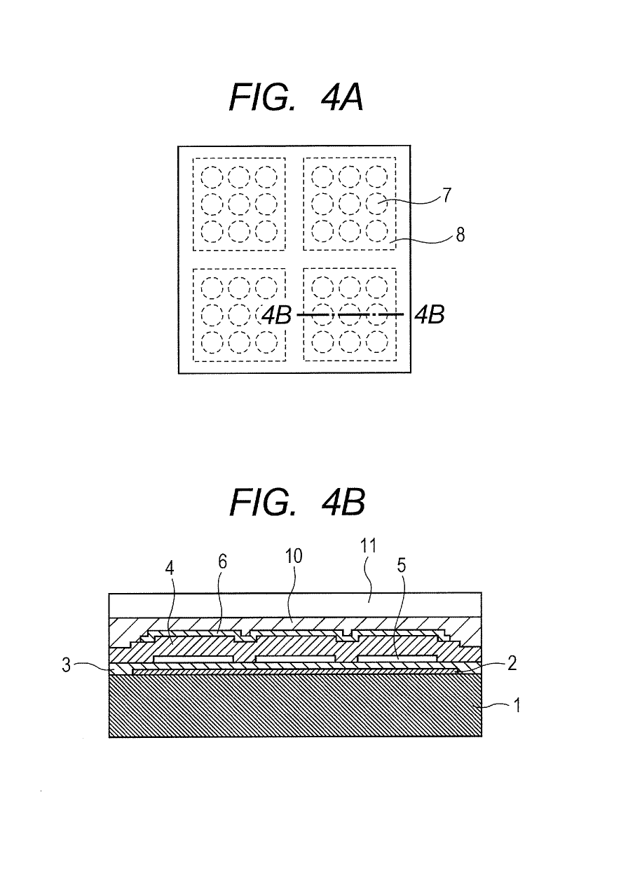

A probe of this embodiment includes a capacitive electromechanical transducer as a detection unit of receiving acoustic waves from an object. An optical reflection member provided on a vibration film (on a side that is closer to an object than an element is) includes a support layer, an optical reflection layer, and a smooth layer that is between the support layer and the optical reflection layer and has a smoother surface than the surface of the support layer. The support layer has a high acoustic wave transparency and, for instance, an acoustic wave transmittance of 90% or higher. The optical reflection layer has a high optical reflectivity, and an optical reflectance of 90% or higher in a wavelength region to be used (e.g. 700 to 1000 nm). The support layer may be a layer made of material selected from resins including methylpentene resin. The smooth layer is made of, for instance, one of thermocuring resin, UV-curing resin and a film made of inorganic material, and can serve as a adhesive layer between the optical reflection layer and the support layer. For instance, a cell of the electromechanical transducer includes: a second electrode formed, via a space, on a first electrode formed in contact with a substrate; a vibration film on which the second electrode is provided; and a vibration film supporter that supports the vibration film such that a space is formed between the first electrode and the vibration film. The cell can be fabricated according to a method of manufacturing any of types called a sacrificial layer type and a bonding type. An example of FIGS. 4A and 4B, which will be described later, includes a structure that can be fabricated according to the method of manufacturing a sacrificial layer type. An example of FIG. 5, which will be described later, includes a structure that can be fabricated according to the method of manufacturing the bonding type. The probe of the present invention, a light source and a data processing device can configure an object information acquisition apparatus. Here, the probe receives acoustic waves caused by irradiation of an object with light emitted from the light source, converts the waves into an electric signal. The data processing device acquires information on the object using the electric signal.

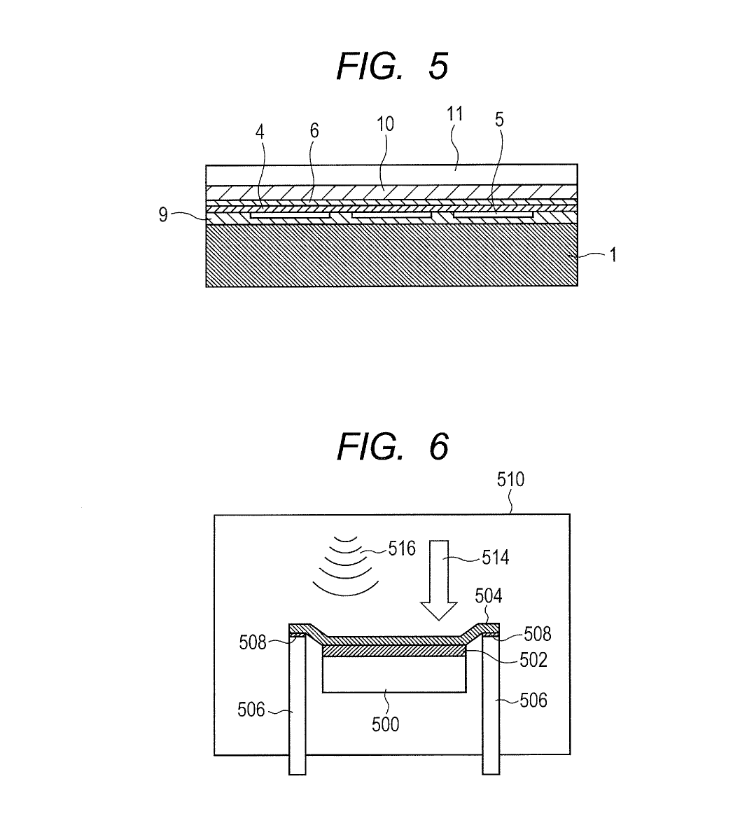

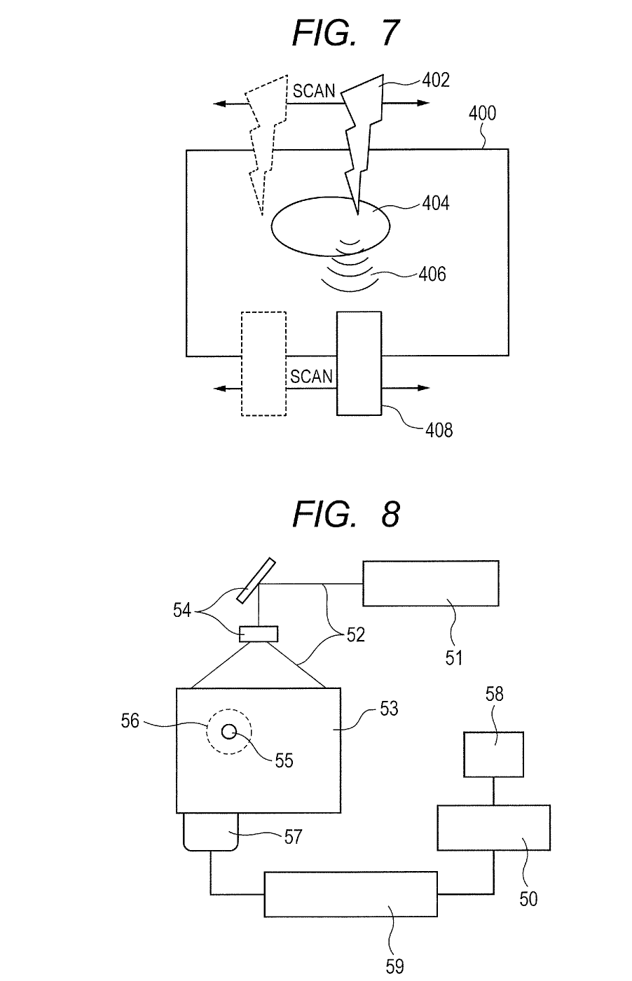

Next, an example of a photoacoustic probe and manufacturing method thereof according to the present invention will be described. FIG. 6 is a schematic diagram of the photoacoustic probe. The probe includes: a device substrate 500 including a CMUT as an ultrasonic sensor; an acoustic impedance matching layer 502 having functions of protecting the CMUT and transmitting ultrasound 516; and an optical reflection member 504 for reflecting a laser beam 514. These components are accommodated in a case 506. The case 506 and the optical reflection member 504 are sealed to each other with adhesive 508, which prevents an acoustic medium 510 from entering the case 506.

The capacitive electromechanical transducer included in the probe of the embodiment of the present invention will be described. FIGS. 4A and 4B illustrate an example of the probe using a capacitive electromechanical transducer including an element having a plurality of cells. FIG. 4A is a top plan view. FIG. 4B is a sectional view of FIG. 4A taken along line 4B-4B. The probe includes a plurality of elements 8 including cells 7. In FIGS. 4A and 4B, each of four elements 8 includes nine cells 7. However, only if at least one cell is included in each element 8, the number of cells is arbitrary.

As illustrated in FIG. 4B, a cell 7 in this embodiment includes a substrate 1, a first electrode 2, an insulation film 3 on the first electrode 2, a vibration film 4 provided on the insulation film 3 via a space 5 (cavity), and a second electrode 6 on the vibration film 4. In the cell 7, a vibration film including one of the two electrodes that are provided so as to interpose a space therebetween is supported in a manner allowing the vibration film to vibrate. The substrate 1 is made of Si. Instead, this substrate may be an insulating substrate made of glass. The first electrode 2 is a metal thin film made of any of titanium and aluminum. In the case where the substrate 1 is made of silicon with a low resistance, the substrate itself can serve as the first electrode 2. The insulation film 3 can be formed by stacking a thin film made of silicon oxide. A vibration film supporter 9 supporting the vibration film 4 and the insulation film 3 is formed by stacking a thin film made of silicon nitride. The second electrode 6 can be formed of a metal thin film made of any of titanium and aluminum. In this specification, the vibration film at a membrane part made of one of a silicon nitride film and a single crystal silicon film, and the second electrode may be collectively called the vibration film.

The probe of this embodiment can be formed using the method of manufacturing a bonding type. A cell 7 having the bonding type configuration illustrated in FIG. 5 includes a vibration film 4 provided on a silicon substrate 1 via a space 5, a vibration film supporter 9 supporting the vibration film 4 in a manner allowing this film to vibrate, and a second electrode 6. Here, the silicon substrate 1 having a low resistance also serves as the first electrode. Instead, the substrate may be an insulating glass substrate. In this case, a metal thin film (one of titanium and aluminum) to serve as the first electrode 2 is formed on the substrate 1. The vibration film 4 is formed of a bonded silicon substrate. Here, the vibration film supporter 9 is made of silicon oxide. Instead, this supporter may be formed by stacking a thin film made of silicon nitride. The second electrode 6 is formed of a metal thin film made of aluminum. FIGS. 4A, 4B, and 5 illustrate an acoustic impedance matching layer 10, and optical reflection member 11 including a smooth layer, which characterizes the present invention.

A principle of driving the probe of this embodiment will be described. The cell is formed of the first electrode 2 and the vibration film that are provided sandwiching the space 5. Accordingly, to receive acoustic waves, a direct current voltage is applied to one of the first electrode 2 and the second electrode 6. When the acoustic waves are received, the acoustic waves vibrate the vibration film to change the distance (height) of the space. Accordingly, the capacitance between the electrodes is changed. The change in capacitance is detected from one of the first electrode 2 and the second electrode 6, thereby allowing the acoustic waves to be detected. The element can also transmit acoustic waves by applying an alternating voltage to one of the first electrode 2 and the second electrode 6 to vibrate the vibration film.

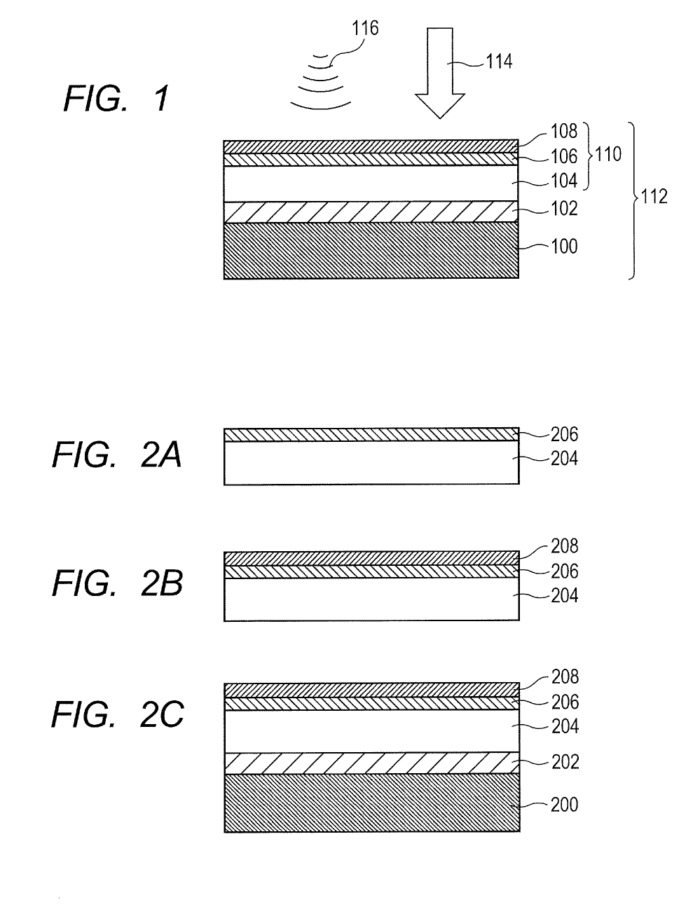

Referring to FIG. 1, the layer configuration on the capacitive electromechanical transducer will be further described in detail. FIG. 1 is a sectional view illustrating the probe. FIG. 1 illustrates a substrate (CMUT substrate) 100 including a CMUT element, an acoustic impedance matching layer 102 formed between the CMUT substrate 100 and a support layer 104, a smooth layer 106, an optical reflection layer 108, and an optical reflection member 110 including the support layer 104, the smooth layer 106 and the optical reflection layer 108. The CMUT substrate 100, the acoustic impedance matching layer 102 and the optical reflection member 110 configure a photoacoustic probe 112. The probe 112 is typically used in an acoustic medium having an acoustic impedance close to that of an object such as a living body. The acoustic medium is, for instance, one of water and polyethylene glycol.

As described above, the CMUT substrate 100 has a configuration which has a membrane made of one of Si and SiN on a cavity formed on the Si substrate. The acoustic impedance matching layer 102 is formed on the CMUT substrate 100 (specifically, on a vibration film including the membrane), and has a function of protecting the membrane and a function of efficiently transmitting ultrasound 116 from an optical reflection member 110 to the CMUT substrate 100. The acoustic impedance matching layer 102 can suitably be made of what has a low Young's modulus that does not largely change mechanical characteristics, such as the spring constant of the membrane. More specifically, a suitable Young's modulus is 50 MPa or less. The Young's modulus of 50 MPa or less alleviates adverse effects on the vibration film due to the stress of optical reflection layer 11. Since the stiffness (Young's modulus) is sufficiently low, the substantial mechanical property of the vibration film 4 is not changed. Furthermore, the acoustic impedance matching layer 102 is suitably made of material having an acoustic impedance equivalent to that of the membrane. More specifically, the suitable acoustic impedance ranges from 1 MRayls to 2 MRayls, inclusive (1 MRayls=1×10⁶ kg·m⁻² ·s⁻¹).

The optical reflection layer 108 is for reflecting a laser beam 114, and provided closer to an object than the element 8 is. More specifically, this layer reflects light emitted on the object and the scattered light. Particularly, in the case of diagnosing a living body, a near-infrared region of wavelengths from 700 to 1000 nm is often used as the laser beam 114. The optical reflection layer 108 can suitably use Au having a high reflectance in the wavelength region (e.g., 700 to 1000 nm) to be used. The optical reflection layer 11 is made of one of Au, Al and a dielectric multilayer reflection film to reflect light having a wavelength used for the light source. The suitable reflectance of the optical reflection layer 11 is at least 80% in the wavelength region of light to be used. The more suitable reflectance is 90% or more. The thickness of the optical reflection layer 108 can be 10 μm or less in consideration of the acoustic impedance. For instance, in the case of Au, the acoustic impedance is about 63×10⁶ [kg·m⁻² ·s⁻¹], which is high. Accordingly, the thickness of the layer is required to be sufficiently reduced to prevent reflection and attenuation of ultrasound due to inconformity of the acoustic impedance. Accordingly, the suitable thickness of the optical reflection layer 11 is 1/30 or lower of the wavelength of the ultrasound in the material. Typically, a photoacoustic ultrasound receiving bandwidth of 10 MHz is sufficient. The suitable thickness of Au is 10 μm or less. An actually suitable thickness is between 0.1 to 1 μm, inclusive, also in consideration of cost. Moreover, a dielectric multilayer film can be formed on the metal film made of Au to configure a layered structure, thereby allowing the reflectance to be further improved. The optical reflection layer may be a dielectric multilayer film.

The support layer 104 is a layer for supporting such an optical reflection layer, and provided closer to the element 8 than the optical reflection layer 108 is. The optical reflection layer 108 can be formed directly on the acoustic impedance matching layer 102. However, this reflection layer can suitably be formed on the support layer 104. The acoustic impedance matching layer 102 is made of material having a low Young's modulus. Accordingly, in the case of forming the optical reflection layer 108 directly on the acoustic impedance matching layer, there is a possibility that the stress from the optical reflection layer deforms the acoustic impedance matching layer. The acoustic impedance matching layer 102 is made of material having a low Young's modulus. It is therefore difficult to reduce the surface roughness. Furthermore, it is difficult to increase the reflectance of the optical reflection layer on the acoustic impedance matching layer. Thus, the optical reflection layer 108 can be suitably formed on the support layer 104 having a higher stiffness than the acoustic impedance matching layer 102. More specifically, the acoustic impedance of the support layer 104 can be between 1 and 5 MRayls, inclusive. The Young's modulus of the support layer 104 is larger (higher) than that of the acoustic impedance matching layer 102, and more specifically, between 100 MPa and 20 GPa, inclusive. The acoustic impedance of the support layer 104 is configured close to the value of the acoustic impedance of the acoustic impedance matching layer 102, thereby allowing the amount of reflection of acoustic waves to be reduced at the interface between the support layer 104 and the acoustic impedance matching layer 102. The suitable material for the support layer 104 can be material having an acoustic impedance equivalent to that of the acoustic medium, not illustrated in FIG. 1, and a favorable ultrasound transparency. For instance, polymethylpentene resin can be used. In consideration of formation of the optical reflection layer and adhesion to the CMUT substrate 100, the suitable material has an appropriate flexibility, and has a thickness between about 10 and 150 μm, inclusive.

The smooth layer 106 is provided between the optical reflection layer 108 and the support layer 104 to improve the surface smoothness of the support layer 104. Thus, the smooth layer 106 has a smoother surface than the surface of the support layer. The suitable surface roughness of the smooth layer 106 is 1/20 or lower of the wavelength of the incident laser beam 114. More specifically, according to the suitable surface roughness of the smooth layer 106, Ra is 40 nm or lower. The layer can be formed by applying and setting liquid material. For instance, one of thermocuring resin and UV-curing resin can be employed. Instead, inorganic material, such as SiO₂ (silicon oxide) and SiN (silicon nitride) can be employed. For smoothing, the thickness of the smooth layer 106 is formed to have a thickness of at least the surface roughness of the support layer 104. In the case with the acoustic impedance largely different from that of the support layer 104 or the acoustic medium, the suitable thickness of the smooth layer 106 is 1/30 or less of the wavelength of ultrasound in the material.

Specific examples will hereinafter be described.

### EXAMPLE 1

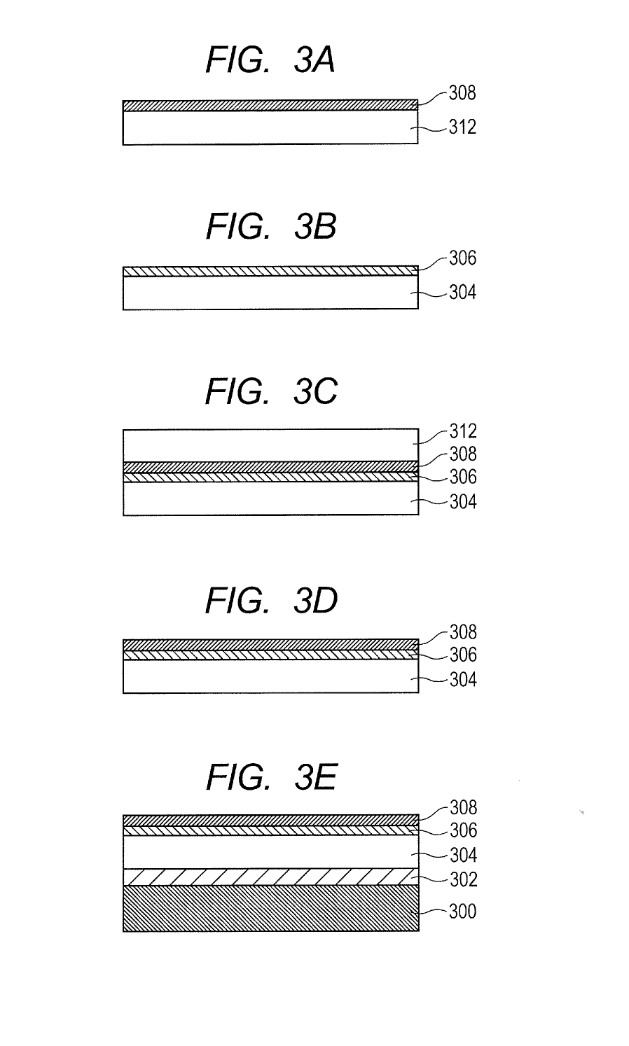

FIGS. 3A to 3E are sectional views illustrating a flow of steps of a method of manufacturing a photoacoustic probe of Example 1. First, as illustrated in FIG. 3A, an optical reflection layer 308 is formed on a substrate 312 for forming an optical reflection layer. In this example, soda-lime glass having a surface roughness (Ra) of 1 nm or less is employed as the substrate 312. However, the material is not necessarily glass. Instead, any material that is smooth and allows the optical reflection layer to be easily exfoliated may be employed. For instance, one of a Si substrate and quartz can be employed. Au (thickness of 500 nm) is formed into the optical reflection layer 308 by a vacuum deposition method. The Au forming method may be the sputtering method. Typically, in the case of forming an Au film on one of glass and Si, the adhesive force is insufficient. Accordingly, one of Ti and Cr is formed as an adhesive layer with a thickness of several to fifty nanometers. However, in this example, the Au film is directly formed without use of the adhesive layer, to allow the film to be easily exfoliated from substrate 312.

Next, as illustrated in FIG. 3B, a smooth layer 306 is formed on a support base 304, which is to be a support layer. In this example, polymethylpentene resin having a thickness of 100 μm is employed as the support layer 304. The surface roughness (Ra) of the polymethylpentene resin is between about 50 and 100 nm, inclusive. Silicone resin adhesive (KE-1830 made by Shin-Etsu Silicone) is applied at a thickness of 10 μm, as the smooth layer 306 having a smoother surface than the surface of the support layer 304, on the polymethylpentene resin by the printing method. The polymethylpentene resin has a low surface energy and insufficient adhesive property. Accordingly, an oxygen plasma process is applied, as a process of improving the adhesive force, for 60 seconds before application of the adhesive. The process of improving the adhesive property may be any of an UV ozone process and a primer process, which can be appropriately selected.

Next, as illustrated in FIG. 3C, the substrate 312, which is for forming the smooth layer and on which Au is formed, is caused to adhere to the support layer 304 on which the smooth layer 306 also serving as the adhesive layer is applied. After adhesion, as illustrated in FIG. 3D, the substrate 312 for forming the smooth layer is removed. The adhesive force between glass and Au is insufficient. Accordingly, the Au layer 308 is favorably transferred on the adhesive layer (smooth layer) 306. The surface smoothness of the glass is reflected in the surface of the Au layer 308, which has a sufficient smooth surface roughness of 3 nm or less, and does not has a pinhole. The Au layer 308 and the adhesive layer (smooth layer) 306 strongly adhere to each other. Next, fluorosilicone resin (X-32-1619 made by Shin-Etsu Silicone) is applied at a thickness of 50 μm, as an acoustic impedance matching layer 302, on the undersurface of the support layer 304 by the printing method. Through use of the resin as adhesive, the layers are, in turn, caused to adhere onto the CMUT substrate 300, as illustrated in FIG. 3E. Because of the same reason, also before the acoustic impedance matching layer 302 is formed on the undersurface of the support layer 304, an oxygen plasma process is applied onto the side of the support layer 304 on which the acoustic impedance matching layer 302 is to be formed, thereby improving the adhesive force between the acoustic impedance matching layer 302 and the support layer 304. The acoustic impedance matching layer 302 may be applied onto the CMUT substrate 300. However, a process of improving the adhesive force of the surface of the support layer 304 in contact with the acoustic impedance matching layer 302 can suitably be performed. As described above, the method of manufacturing the probe of this embodiment includes the steps of: preparing a substrate that is for forming an optical reflection layer and has a smooth surface; forming the optical reflection layer on the substrate for forming the optical reflection layer in a state where a adhesive force is small; forming a smooth layer that also serves as an adhesive layer and has a smoother surface than a surface of the support layer, on a support base to be a support layer; and causing the optical reflection layer to adhere to the smooth layer, subsequently removing the substrate for forming the optical reflection layer using a property where the adhesive force between the substrate for forming the optical reflection layer and the optical reflection layer is smaller than a adhesive force between the support layer and the smooth layer, and transferring the optical reflection layer onto the smooth layer.

### EXAMPLE 2

FIGS. 2A to 2C are diagrams illustrating another example of the present invention. In Example 2, as illustrated in FIG. 2A, silicone resin adhesive (KE-1830 made by Shin-Etsu Silicone) is applied at a thickness of 10 μm as a smooth layer 206, on a support layer 204 made of polymethylpentene resin having a thickness of 100 μm, by the printing method. A heat treatment is applied at 120° C. for 60 minutes to sufficiently set the layer. The surface roughness (Ra) of the polymethylpentene resin before forming the smooth layer 206 is between about 50 and 100 nm, inclusive. After forming and setting the smooth layer 206, measurement shows that the surface roughness (Ra) is between about 10 and 20 nm, inclusive, and sufficient smoothing is confirmed. That is, the smooth layer 206 has a smoother surface than the surface of the support layer 204.

Next, as illustrated in FIG. 2B, an optical reflection layer 208 is formed by sequentially stacking Cr (with a thickness of 10 nm), Au (with a thickness of 200 nm) on the smooth layer 206 using a sputtering method. Here, the Cr film is thus formed before the Au film is formed for improving the adhesive property to the smooth layer 206. The surface roughness (Ra) of the formed optical reflection layer 208, in which the surface of the smooth layer 206 is reflected, is between about 10 and 20 nm, inclusive. No pinhole is formed. After the smooth layer 206 and the optical reflection layer 208 are thus formed on the support layer 204, 40 μm of fluorosilicone resin (X-32-1619 made by Shin-Etsu Silicone) is applied by a printing method as an acoustic impedance matching layer 202 on the undersurface of the support layer 204. This layer is used as adhesive to cause the layers to adhere onto a CMUT substrate 200, as illustrated in FIG. 2C. Before the acoustic impedance matching layer 202 is applied on the support layer 204, an oxygen plasma process is applied to the application surface of the support layer 204 on which the acoustic impedance matching layer 202 is to be applied to improve the adhesive force between the support layer 204 and the acoustic impedance matching layer 202.

### EXAMPLE3

SiO₂ film is applied at a thickness of 0.2 μm as a smooth layer 206 on a support layer 204 made of polymethylpentene resin having a thickness of 50 μm using the sputtering method. The surface roughness (Ra) of the polymethylpentene resin before forming the smooth layer 206 is between about 40 and 60 nm, inclusive.

After forming and setting the smooth layer 206, measurement shows that the surface roughness (Ra) is equal to or less than 20 nm.

Next, Cr film and Au film are sequentially formed on the smooth layer 206 by deposition method to form an optical reflection layer 208.

The Ra of the obtained optical reflection layer is equal to or less than 20 nm. Thus, the support layer 204 with the optical reflection layer 208 thereon is adhered onto a CMUT substrate 200 via acoustic impedance matching layer 202.

### COMPARATIVE EXAMPLE

To confirm the advantageous effects of the present invention, a photoacoustic probe is fabricated as a comparative example; the probe is fabricated according to steps analogous to those of Example 2 but has a configuration in which the smooth layer 206 is not formed. More specifically, an optical reflection layer is formed by successively stacking Cr (with a thickness of 10 nm) and Au (with a thickness of 200 nm) on polymethylpentene resin having a thickness of 100 μm using the sputtering method. Subsequently, as with Example 2, the acoustic impedance matching layer is formed, and caused to adhere to the CMUT substrate, thus fabricating the photoacoustic probe. In the comparative example, the surface roughness of Au is between about 50 and 100 nm, inclusive, which is substantially equivalent to that of polymethylpentene resin. Pinholes considered to be due to the surface roughness of polymethylpentene resin are observed.

The photoacoustic probes fabricated according to the comparative example and Examples 1 and 2 are stored in probe cases respectively, sealed, and subjected to the following processes. The probes are soaked in polyethylene glycol (with an acoustic impedance of about 1.8×10⁶ [kg·m⁻² ·s⁻¹]), which is an acoustic medium. A titanium-sapphire laser is used to irradiate the optical reflection layers with a laser beam having a wavelength of 800 nm and an intensity of 10 mJ/cm². The acoustic noise is compared. The acoustic noise of the probes fabricated in Examples 1 and 2 is reduced to be about ⅓ to ⅕ of that of the comparative example. To evaluate the adhesive force of the optical reflection layer, the adhesive force is examined using a cross cut method. More specifically, 5×5 indentions at 1-mm intervals are made on the optical reflection layer. A test is performed using a tape having an adhesive force of 3.93 N/10 mm. As a result, zero among samples fabricated according to Examples 1 and 2 are exfoliated. In contrast, 25 among 25 samples according to the comparative example are exfoliated. It is thus confirmed that the smooth layer of the present invention improves the adhesive force of the optical reflection layer.

### EXAMPLE 4

The probe including the electromechanical transducer described in the embodiments and the examples is applicable to an object information acquisition apparatus using acoustic waves. Acoustic waves from an object are received by the electromechanical transducer. Through use of an output electric signal, object information in which an optical property value of the object, such as the optical absorption coefficient, is reflected can be acquired.

FIG. 8 illustrates an object information acquisition apparatus using photoacoustic effects according to this example. An object 53 is irradiated with pulsed light 52 emitted from a light source 51 via optical elements 54, such as a lens, a mirror and an optical fiber. A light absorber 55 in the object 53 absorbs the energy of the pulsed light and generates photoacoustic waves 56, which are acoustic waves. A probe 57 including a casing for accommodating an electromechanical transducer receives the photoacoustic waves 56, converts the waves into an electric signal and outputs the signal to a signal processor 59. The signal processor 59 performs a signal process, such as A/D conversion and amplification, on the input signal, and outputs the signal to a data processor 50. The data processor 50 acquires object information (object information in which an optical property value of the object, such as an optical absorption coefficient is reflected) as an image data, using the input signal. The display 58 displays an image based on the image data input from the data processor 50. The probe may be any of a type of being mechanically scanned and a type (hand-held type) of being moved by a user, such as any of a doctor and a technician, with respect to an object.

According to the present invention, the smooth layer is formed on the support layer and then the optical reflection layer is formed thereon. This configuration improves smoothness of the optical reflection layer and, in turn, improves the reflective performance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-083418, filed Mar. 31, 2012, and Japanese Patent Application No. 2013-040131, filed Feb. 28, 2013, which are hereby incorporated by reference herein in their entirety.

What is claimed is:

1. A probe receiving an acoustic wave from an object, comprising:
an element having at least one cell in which a vibration film containing one electrode out of two electrodes that are provided so as to interpose a space therebetween is vibratably owing to the acoustic wave;
an optical reflection layer that is provided closer to the object than the element is;
a support layer that is provided closer to the element than the optical reflection layer is, and supports the optical reflection layer; and
a smooth layer that is provided between the support layer and the optical reflection layer and has a smoother surface than the surface of the support layer.

2. The probe according to claim 1,
wherein the probe receives the acoustic wave caused in the object by irradiation of light, and
a surface roughness of the smooth layer is equal to or less than 1/20 of a wavelength of the light.

3. The probe according to claim 1, wherein the smooth layer has a larger thickness than a surface roughness of the support layer.

4. The probe according to claim 1, wherein the smooth layer has a thickness equal to or less than 1/30 of a wavelength of the acoustic wave.

5. The probe according to claim 1, wherein the smooth layer is one of an SiO₂ film and an SiN film.

6. The probe according to claim 1, wherein the smooth layer is made of one of thermocuring resin and UV-curing resin.

7. The probe according to claim 1,
wherein the element receives an acoustic wave caused by irradiation with light on the object, and
the optical reflection layer has an optical reflectance of at least 80% in a wavelength region of the light.

8. The probe according to claim 1, wherein the optical reflection layer has a thickness equal to or less than 1/30 of a wavelength of the acoustic wave.

9. The probe according to claim 1, wherein the optical reflection layer is one of a metal film and a dielectric multilayer film, or has a layered structure of a metal film and a dielectric multilayer film.

10. The probe according to claim 1, wherein the support layer has an acoustic impedance between 1 and 5 MRayls, inclusive.

11. The probe according to claim 1, wherein the support layer has a Young's modulus between 100 MPa and 20 GPa, inclusive.

12. The probe according to claim 1, wherein the support layer is made of one of methylpentene resin and polyethylene.

13. The probe according to claim 1, further comprising an acoustic impedance matching layer between the support layer and the element.

14. The probe according to claim 13, wherein the acoustic impedance matching layer has an acoustic impedance between 1 and 2 MRayls, inclusive.

15. The probe according to claim 13, wherein the acoustic impedance matching layer has a Young's modulus equal to or less than 50 MPa.

16. An object information acquisition apparatus, comprising: the probe according to claim 1; a light source; and a data processing device, wherein the probe receives an acoustic wave caused by irradiation on the object with light emitted from the light source and converts the wave into an electric signal, and
the data processing device acquires information on the object using the electric signal.

17. A method of manufacturing the probe according to claim 1, comprising:
preparing a substrate for forming the optical reflection layer;
forming the optical reflection layer on the substrate for forming the optical reflection layer;
forming a smooth layer having a smoother surface than a surface of the support layer, on a support base to be the support layer; and
causing the optical reflection layer to be in contact with the smooth layer, subsequently removing the substrate for forming the optical reflection layer using a property where a adhesive force between the substrate for forming the optical reflection layer and the optical reflection layer is smaller than a adhesive force between the support layer and the smooth layer, and transferring the optical reflection layer onto the smooth layer.
